(19) United States
(12) Patent Application Publication
(10) Pub. No.: US 2025/0123816 A1
(43) Pub. Date: Apr. 17, 2025

(54) APPLICATION DEVELOPMENT PLATFORMS AND METHODS, DEVICES, AND STORAGE MEDIUMS

(71) Applicant: BOE Technology Group Co., Ltd., Beijing (CN)

(72) Inventors: Sujia JIANG, Beijing (CN); Zhe ZHANG, Beijing (CN); Chao WANG, Beijing (CN); Kun LI, Beijing (CN); Mingming YANG, Beijing (CN); Hongxiang SHEN, Beijing (CN)

(21) Appl. No.: 18/688,079

(22) PCT Filed: Dec. 27, 2022
(86) PCT No.: PCT/CN2022/142225

§ 371 Date: Feb. 29, 2024

(51) Int. Cl. G06F 8/34

(52) U.S. Cl. CPC G06F 8/34

(57) ABSTRACT

The present disclosure discloses an application development platform and method, a device, and a storage medium. The platform includes: a program development module, configured to display a page editing interface; and generate a page program according to a user's operation on the page editing interface, where the operation includes generating a page layout using materials and components, and configuring page information for the page layout; a mid-end configuration module, configured to configure an application mid-end for the page program; and an application module, configured to integrate the page program and the application mid-end to obtain an application program.

### TECHNICAL FIELD

The present disclosure relates to the technical field of computer application, in particular to application development platforms and methods, devices, and storage mediums.

### BACKGROUND

With the popularization of the Internet, applications with various functions are favoured by users, for example, online shopping applications, audio and video applications, gaming applications, and so on.

However, the current application development process is usually cumbersome, and the threshold for developers is high, making it difficult to improve the efficiency of application development.

### SUMMARY

The present disclosure provides platforms and methods for application development, devices, and storage mediums to address deficiencies in related technologies.

According to the first aspect of the embodiments of the present disclosure, an application development platform is provided, and includes:
a program development module, configured to display a page editing interface; and generate a page program according to a user's operation on the page editing interface, where the operation includes generating a page layout using materials and components, and configuring page information for the page layout;
a mid-end configuration module, configured to configure an application mid-end for the page program; and
an application module, configured to integrate the page program and the application mid-end to obtain an application program.

In some embodiments, the program development module is configured to:
by a pre-developed conversion module, converting a user's operation on the page editing interface into an intermediate component used to represent a page layout and/or page information in the page layout, and generating a page program composed of the intermediate component.

In some embodiments, the conversion module is developed based on a cross-platform framework;
The intermediate component is configured to be parsed into actual executable code under the cross-platform framework.

In some embodiments, the application module is configured to:
parsing the intermediate component of the page program into the actual executable code under the cross-platform framework to obtain an executable page program; and integrating the executable page program and the application mid-end to obtain the application program.

In some embodiments, the platform further includes:
a material management module, configured to display a material editing interface; and according to a user's operation on the material editing interface, generate a new edited material based on an existing material.

In some embodiments, the material management module is configured to: according to the user's operation on the material editing interface, by a basic material component pre-determined based on the cross-platform framework, converting a basic material component combination corresponding to the existing material into a basic material component combination corresponding to the new edited material; where
the basic material component is configured to be parsed into a basic material under the cross-platform framework.

In some embodiments, the page information includes:
page attribute information, page event information, page data information, page interaction information, page-to-page relationship information, or any combination thereof.

In some embodiments, the application mid-end is configured to push page data, update page data, summarize page data, or any combination thereof; and
the mid-end configuration module is configured to determine page data to be pushed, page data to be updated, page data to be summarized, or any combination thereof in the page program.

In some embodiments, the platform further includes:
a deployment module, configured to deploy at least one module of the application development platform to a demand side according to requirements of the demand side.

According to the second aspect of the embodiments of the present disclosure, an application development method is provided, and includes:
displaying a page editing interface; and generating a page program according to a user's operation on the page editing interface, where the operation includes generating a page layout using materials and components, and configuring page information for the page layout;
configuring an application mid-end for the page program; and
integrating the page program and the application mid-end to obtain an application program.

In some embodiments, generating the page program according to the user's operation on the page editing interface includes:
by a pre-developed conversion module, converting a user's operation on the page editing interface into an intermediate component used to represent a page layout and/or page information in the page layout, and generating a page program composed of the intermediate component.

In some embodiments, the conversion module is developed based on a cross-platform framework;

The intermediate component is configured to be parsed into actual executable code under the cross-platform framework.

In some embodiments, integrating the page program and the application mid-end to obtain the application program includes:
parsing the intermediate component of the page program into the actual executable code under the cross-platform framework to obtain an executable page program; and integrating the executable page program and the application mid-end to obtain the application program.

In some embodiments, the method further includes:
displaying a material editing interface; and according to a user's operation on the material editing interface, generating a new edited material based on an existing material.

In some embodiments, according to the user's operation on the material editing interface, generating the new edited material based on the existing material includes:
according to the user's operation on the material editing interface, by a basic material component pre-determined based on the cross-platform framework, converting a basic material component combination corresponding to the existing material into a basic material component combination corresponding to the new edited material; where
the basic material component is configured to be parsed into a basic material under the cross-platform framework.

In some embodiments, the page information includes:
page attribute information, page event information, page data information, page interaction information, page-to-page relationship information, or any combination thereof.

In some embodiments, the application mid-end is configured to push page data. update page data, summarize page data, or any combination thereof; and
configuring the application mid-end for the page program includes: determining page data to be pushed, page data to be updated, page data to be summarized, or any combination thereof in the page program.

In some embodiments, the method further includes:
deploying at least one module of the application development platform to a demand side according to requirements of the demand side.

According to the above embodiments, the application development platform can standardize the application development process as developing pages, configuring application mid-end, and integrating, which achieves standardization and modularization of application development process. Development and configuration through user's editing operations can lower the development threshold and improve the efficiency of application development.

It is to be understood that the above general descriptions and the below detailed descriptions are merely exemplary and explanatory, and are not intended to limit the present disclosure.

### BRIEF DESCRIPTION OF DRAWINGS

Accompanying drawings herein are incorporated into and constitute a part of the specification, illustrate embodiments consistent with the present disclosure, and are combined with the description to explain the principle of the present disclosure.

FIG. 1 is a structural schematic diagram of an application development platform according to the embodiments of the present disclosure.

FIG. 2 is a schematic diagram of an operation interface of a material management module according to the embodiments of the present disclosure.

FIG. 3 is a schematic diagram of a page editing interface of a program development module according to the embodiments of the present disclosure.

FIG. 4 is a schematic diagram of different attribute panels of different components in a page editing interface of a program development module according to the embodiments of the present disclosure.

FIG. 5 is a schematic diagram of an event panel in a page editing interface of a program development module according to the embodiments of the present disclosure.

FIG. 6 is a schematic diagram of a data panel in a page editing interface of a program development module according to the embodiments of the present disclosure.

FIG. 7 is a flowchart of an application development method according to the embodiments of the present disclosure.

FIG. 8 is a schematic diagram of a hardware structure of a computer device configured to perform methods of the embodiments of the present disclosure according to the embodiments of the present disclosure.

### DETAILED DESCRIPTION

Embodiments will be described in detail herein, examples of which are illustrated in the accompanying drawings. Where the following description refers to the drawings, elements with the same numerals in different drawings refer to the same or similar elements unless otherwise indicated. Embodiments described in the illustrative examples below are not intended to represent all embodiments consistent with the present disclosure. Rather, they are merely embodiments of devices and methods consistent with some aspects of the present disclosure as recited in the appended claims.

With the popularization of the Internet, applications with various functions are favoured by users, for example, online shopping applications, audio and video applications, gaming applications, and so on.

However, the current application development process is usually cumbersome, and the threshold for developers is high, making it difficult to improve the efficiency of application development.

To improve the efficiency of application development, the embodiments of the present disclosure provide an application development platform.

In the application development platform, the process of the application development can be standardized and modularized, and some operations can be simplified through low code, thereby improving the efficiency of application development.

The process of application development can be standardized as developing pages, configuring application mid-end, and integrating. Developing pages and configuring application mid-end can be developed and configured in a low code manner through editing operations, thereby reducing the development threshold and improving the efficiency of application development.

Below is a detailed explanation of an application development platform provided in the embodiments of the present disclosure.

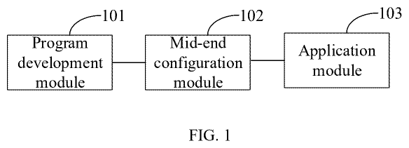

FIG. 1 is a structural schematic diagram of an application development platform according to the embodiments of the present disclosure. As show in FIG. 1.

the application development platform can include the following modules.

A program development module 101 is configured to display a page editing interface; and generate a page program based on user's operations on the page editing interface.

In some embodiments, user's operations on the page editing interface may at least include generating a page layout using materials and components, and configuring page information for the generated page layout.

A mid-end configuration module 102 is configured to configure an application mid-end for the generated page program.

An application module 103 is configured to integrate the generated page program and the configured application mid-end, to obtain an application program.

The application development platform can standardize the application development process as developing pages, configuring application mid-end, and integrating, which achieves standardization and modularization of application development process. Development and configuration through user's editing operations can lower the development threshold and improve the efficiency of application development.

Below are detailed explanations for each module.

1. A program development module 101 is configured to display a page editing interface; and generate a page program based on user's operations on the page editing interface.

The embodiments of the present disclosure do not limit specific user's operations.

In some embodiments, user's operations on the page editing interface may at least include generating a page layout using materials and components, and configuring page information for the generated page layout.

For ease of understanding. a page layout can include a layout of various elements on the page, such as positions, sizes, stacking relationships, occlusion relationships, etc. The page information can include relevant information of various elements on the page, such as transparency, attributes, interactive animations of elements (also referred as page elements) in the page.

The embodiments of the present disclosure do not limit specific page information.

In some embodiments, page information may include page attribute information, page event information, page data information, page interaction information, page-to-page relationship information, or any combination thereof.

In some embodiments, page attribute information may include attribute information of elements in the page. For example, the attribute information may include position, size, shape, transparency, rounded corner, filler color, border style, border color, or any combination thereof.

In some embodiments, page event information may include relevant event information of elements in the page. For example, click trigger events, drag trigger events, and double-click trigger for elements in the page.

For ease of understanding, page events can be structured as “target element-triggering operation-behaviour”, which means that for a certain target element, an operation triggers an event, and a corresponding behaviour is executed.

The triggering operations mainly include: (1) Click, (2) Double click, (3) Right click, (4) Pressing the mouse down, (5) Releasing the mouse, and (6) The mouse entering.

Corresponding behaviours, such as: (1) Jumping to page, (2) Data loading, (3) Returning to page, (4) Custom event, (5) Going back, (6) jsBridge, and (7) Data transferring.

In some embodiments, page data information may include relevant data information of elements in the page, such as characters that need to be displayed in elements in the page, or characters that are displayed after operation.

In some embodiments, page interaction information may include relevant information of page elements during the interaction process, such as animation operations of page elements during the interaction process.

In some embodiments, page-to-page relationship information may include jump or conversion relationships between pages. For example, a single application can include multiple pages, which allows for jumping between different pages. For example, a jump can be triggered by an operation.

### 1) Page Editing

The embodiments of the present disclosure do not limit the specific page editing interface, as long as it is used for editing the page.

In an embodiment, page editing can be done in a low code manner. For example, page can be edited visually, for example, page elements or components can be dragged and dropped for placement, configuring information of page elements, etc.

In some embodiments, by low code page editing operations, the corresponding page program can be generated to display the corresponding page layout and page information.

The embodiments of the present disclosure do not limit the specific method of generating page programs.

In some embodiments, a page program composed of actual executable code can be generated to display the edited page. The page can include a page layout and page information.

In some embodiments, in order to facilitate the undo of page editing and viewing of the page program, intermediate products that are convenient for viewing can further be used to constitute the page program, such as components.

In some embodiments, the program development module 101 can be configured to, by a pre-developed conversion module, convert a user's operation on the page editing interface into an intermediate component used to represent a page layout and/or page information in the page layout, and generate a page program composed of the intermediate component.

The embodiments of the present disclosure do not limit the form of the intermediate component. In some embodiments, the intermediate component may be in the form of pseudocode, such as pseudocode in JSON format, which is convenient to view and modify, and to run and update in a timely manner.

In some embodiments, a running process can parse the page program composed of intermediate components and display the corresponding page. Therefore, a page program composed of intermediate components can achieve hot updates. The page program can be modified, and the running process parse the modified page program, to display the corresponding modified page.

In some embodiments, intermediate components can be configured to be parsed into actual runnable code.

### 2) Cross-Platform

In an embodiment, in order to reduce the development cost of the application, a single application development can be carried out for multiple platforms, to obtain different application versions for the multiple platforms based on a cross-platform framework, thereby improving the development efficiency of the application.

Therefore, in some embodiments, the application development platform in the embodiments of the present disclosure may be developed based on a cross-platform framework.

The embodiments of the present disclosure do not limit specific cross-platform framework. In some embodiments, the cross-platform framework can be the Flutter cross-platform framework or other cross-platform frameworks.

In some embodiments, corresponding intermediate components can be developed based on the cross-platform framework, which can correspond to functional components of actual executable code under cross-platform frameworks. For example, it can be functional pseudocode.

For example, reloadData is for data loading. After clicking is triggered on panel A. panel B will receive a notification. This notification can be bound based on the GlobleKey set under the Flutter cross-platform framework and remains active at runtime. When a message is received from A, B's behavior tree receives the information from reloadData and calls the setState( ) method to automatically refresh all content of panel B, thereby achieving the function of data loading.

For the implementation code of this function under the cross-platform framework, it can be identified by the intermediate component of data loading, which can be used as the function of data loading to generate the page program, so as to parse the intermediate component into the corresponding function implementation code in the future.

In some embodiments, the conversion module may be developed based on a cross-platform framework. The intermediate component can be configured to be parsed into actual executable code under the cross-platform framework.

Correspondingly, the developed page program can run on different platforms.

In this embodiment, by the cross-platform framework, application development efficiency can be further improved. Through a single development. different application versions that are compatible with multiple platforms can be obtained.

### 3) Material Management

In an embodiment, the application development platform in the embodiments of the present disclosure may further include a module for managing page materials, i.e., a material management module 104.

In some embodiments, the material management module 104 can be configured to edit materials, manage materials, and perform displaying, updating, and other operations.

In some embodiments, the material management module 104 can be configured to display a material editing interface; and according to a user's operation on the material editing interface, generate a new edited material based on an existing material.

In an embodiment, to achieve cross-platform development, the editing of materials can also be based on a cross-platform framework.

In some embodiments, the material management module 104 can be configured to: according to the user's operation on the material editing interface, by a basic material component pre-determined based on the cross-platform framework, converting a basic material component combination corresponding to the existing material into a basic material component combination corresponding to the new edited material; where basic material components can be used to be parsed into basic materials under the cross-platform framework.

In this embodiment, it is precisely because the basic materials under the cross-platform framework are adopted, and new materials are further obtained through editing, such that the new materials can also be applied under the cross-platform framework, which achieves cross-platform development and improving application development efficiency.

### 4) Example

For ease of understanding, the embodiments of the present disclosure further provide an example.

The foundation of material management is a visual editor equipped with a cross-platform framework, the visual editor is also used for page editing, and the main difference is that material management is used to manage basic UI styles: basic elements/basic panels/business panels.

A cross-platform engine is mainly for, in the cross-platform framework based on Flutter, combined with the low code requirements of the platform, describing each code instance on the platform as a recognizable language that can be described through JSON.

For example, it can involve 16 panel components: box container/text/row container/column container/button/image/checkbox/input box/carousel/switch/list/bar chart/pie chart/line chart/radar chart/circular chart/curve chart/area chart. These 16 components are the most fundamental elements in material management.

In addition to the description of the above interfaces, it is further compatible with technical attributes such as layout/position/transparency/color.

In this engine, all elements and instances are strings. The strings are linked to the layout through visual configuration to form a set of visual editors for visual editing of interface properties, association of interactive events, and data binding. Combined with the material center/page/product management, the corresponding code instances/application products/visual pages can be generated with functions described by the strings, and the output can be browsed online.

The development process mainly determines what properties a component needs to have to accommodate external modification requirements. This process supports Flutter's native basic UI elements and also supports custom panel components, to instantiate and display the corresponding properties, and associate the corresponding properties with the component's instance through code. Finally, the component will form a JSON string for describing the UI style. The string mainly contains the description of the layout of the element, such as coordinates, size, and some page attributes (color, border, rounded corners, data). Elements usually pass in some default static data, which can be edited externally. After editing, the field used to describe the data in the JSON will be replaced. It also supports data parsing requested by the data interface. When the event binding function is called on the page, a globally controlled event field JSON will be added, where this JSON describes the data transfer direction and next behavior of a panel or element during command execution.

This embodiment mainly relies on the key-value one-to-one matching principle to convert instances and strings into each other to abstract them into visible pseudocode, and the upper-level visualization configurator operates on this pseudocode to modify properties/interactions/events/data of the pseudocode.

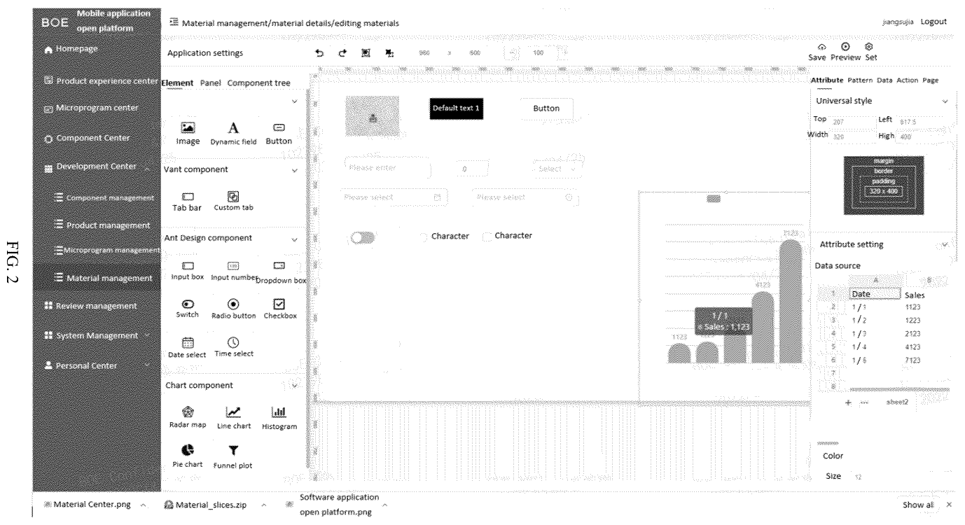

FIG. 2 is a schematic diagram of an operation interface of a material management module according to the embodiments of the present disclosure. As show in FIG. 2,

Users can create corresponding material folders in the material management module, select the corresponding application platform (Web/Mobile/Windows), where Web is divided into H5/Management end/Workflow, and Mobile is divided into App/Work Order.

The example shown in FIG. 2 is created by a cross-platform engine. The UI style is modified on the page by visually configuring the corresponding properties. In fact, the values filled in on the page and Parser (each component of the cross-platform engine has a Parser to parse the component) in the material instantiate the material, and all the materials configured on the editing page in FIG. 2 can form a new material. Since internal parsing has already been done one by one, the layout of the entire page can also be automatically parsed externally through the layout method and parameter passing method specified by the cross-platform engine.

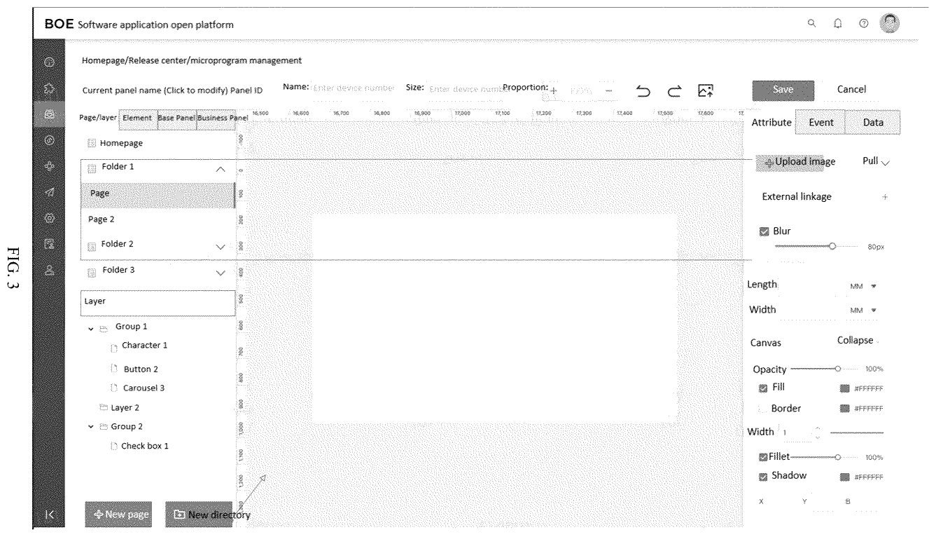

FIG. 3 is a schematic diagram of a page editing interface of a program development module according to the embodiments of the present disclosure. As shown in FIG. 3, It is mainly divided into three parts: 1. Left page management 2. Right configuration 3. Middle canvas.

The page management on the left side is further divided into: 1. Page tree (all pages, each representing a page on the App or management end); 2. Layer Tree: the layer tree is the layers of the currently selected page; 3. Element: the content of the element reads the basic panel elements generated by the cross-platform engine in the material center; 4. Basic panel: it is a commonly used panel composed of element splicing, generated through material management; 5. Business Panel: the business panel is composed of elements and basic panels that is edited through material management, and has certain business attributes.

The page tree provides the function of adding and selecting pages. The newly added pages represent their actual pages on the app or management end, and the entire page is moved through event binding, including clicking, jumping and parameter passing.

The configuration on the right side is mainly divided into three parts: 1. Properties, 2.Events, and 3. Data. Corresponding switches will be made based on the selected components. For example, if the carousel and switch elements are selected, the panel's property configuration will also change accordingly. The basis for changing its properties is also determined by the properties defined by the components described in the cross-platform engine.

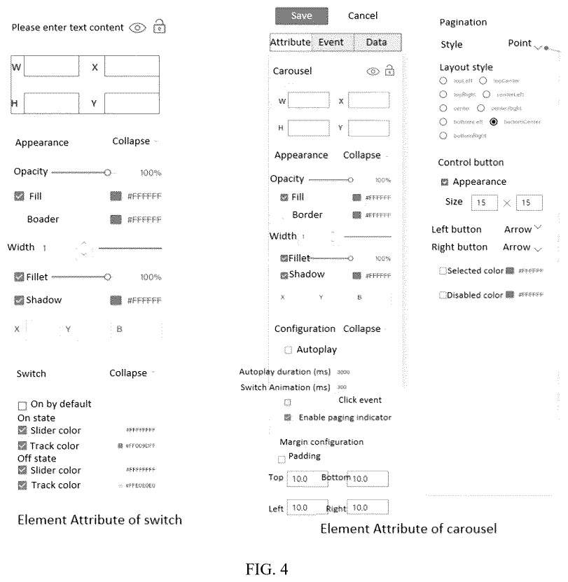

FIG. 4 is a schematic diagram of different attribute panels of different components in a page editing interface of a program development module according to the embodiments of the present disclosure.

FIG. 4 shows the element attribute panels respectively corresponding to the switch component and the carousel component.

When dragging a panel to a component, what is being dragged is the corresponding string. After parsing this string into the corresponding instance, its properties will also be parsed into a set of key-value one-to-one matching content.

Taking color as an example, after receiving a field that needs to be matched with color, it will automatically configure a color selector. During the development process, the result of the color selector will be inserted back into the value of the color field, and then the color will be synchronized at runtime. And each element will have an attribute list like color, and each element's attribute list is different.

The same goes for event. The event is divided into two parts: 1. Interaction actions 2. Data interaction, where interaction actions mainly involve displaying, hiding, displacement, pop ups, etc. of the panel, and data interaction mainly involves determining the parameter passing content of the target panel through the key to the value obtained by the current panel in data binding. The value of panel A is passed to panel B through JSON binding for parameter receiving. After the corresponding data is received at runtime, the data will be passed to the corresponding panel for data refresh.

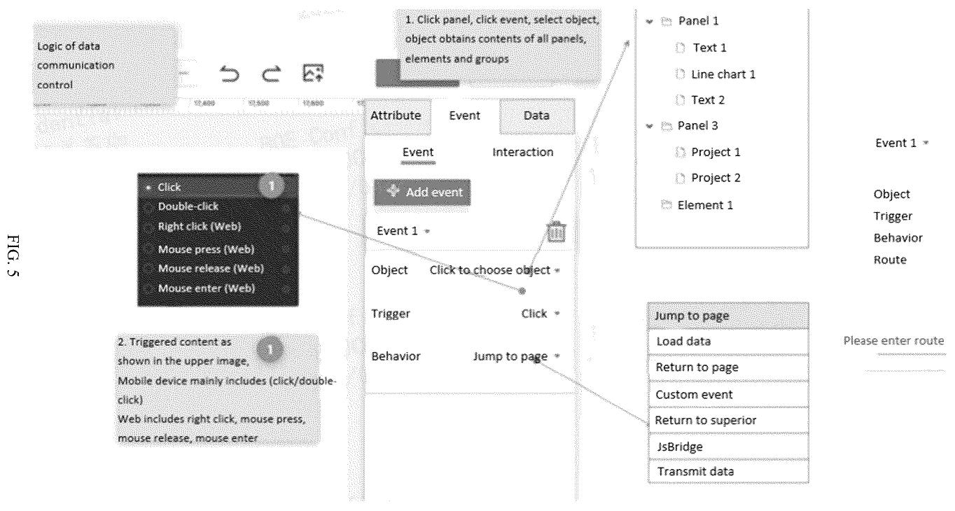

FIG. 5 is a schematic diagram of an event panel in a page editing interface of a program development module according to the embodiments of the present disclosure. As shown in FIG. 5,

The events that trigger interaction mainly include: 1. Clicking, 2 Double clicking, 3. Right clicking, 4. Pressing the mouse, 5. Releasing the mouse, and 6. The mouse entering. Then, the corresponding behaviour can be selected, such as 1. Jumping to page, 2. Data loading, 3. Returning to page, 4. Custom event, 5. Going back, 6. jsBridge, and 7. Data transferring. The subordinate pages formed by each functional module are also different. It is mainly based on a behaviour tree to describe the behaviour of the component.

This description process also exists in the cross-platform engine. By describing behaviour and departure logic as corresponding key data, such as reloadData being data loading, after clicking on A panel, B panel will receive a notification. This notification is actually bound based on the GlobleKey set in the Flutter project and remains active at runtime. When receiving information from A, B's behavior tree receives information from reloadData, and the setState( ) method will be called to automatically refresh all contents of the B panel.

The transmission of values is mainly through the logic generation of jsonPath in data binding.

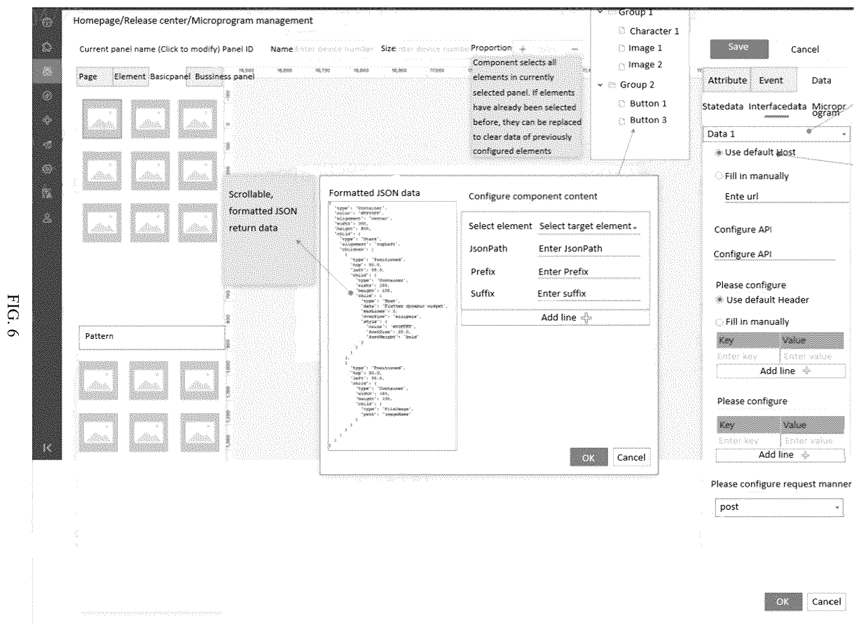

FIG. 6 is a schematic diagram of a data panel in a page editing interface of a program development module according to the embodiments of the present disclosure. As shown in FIG. 6,

Data binding can be divided into three binding methods: 1. static data (directly converted to JSON), 2. interface data (used to undertake interface data for business line), 3. microservice platform data (automatically generated by the backend low code platform).

By filling in the corresponding host, API, header, parameter passing, and request method, dynamic interface data is obtained, and the values of the interface data are displayed.

For a panel, a panel has multiple elements that can be configured with corresponding jsonPath, and the value returned by interface can be directly read during parsing. For the panel, the panel is a component with overall parsing. Inside, traverse can be performed based on the number of interfaces passed in, and the jsonPath of each element will be passed into the data such as Text. The data is used to place the default static data. The result obtained after parsing jsonPath outside the panel can directly replace the default static data in the data, such that the data can be transferred.

For the values passed through event binding, after receiving a notification from Gloable, the panel receives dynamic values when receiving parameters. The value of the parameter is obtained through the overall parameter table of the hook page. Similarly, the key-value relationship passed from the upper page is obtained through the preParams field of a field like the data. After one-to-one comparison, the key-value relationship is passed to the request parameter field param representing the panel, to perform a request, such that the data can be refreshed.

The middle canvas section mainly involves general configuration operations such as dragging, zooming in, layout, dividing, grouping, and selection. The page configuration is linked through the coordination of the middle canvas and the left and right sides.

Click OK to generate pseudocode (cross-platform engine parsing result) that covers data binding, time binding, and UI (material management). At the same time, each page will be truncated to generate a set of page displays, which will be recorded in the created page content.

2. A mid-end configuration module 102 is configured to configure an application mid-end for the generated page program.

In some embodiments, the application mid-end can be configured to implement communication functions in the generated application, for data communication with external parties. For example, it can be achieved through componentization.

In some embodiments, the application mid-end is configured to push page data, update page data, summarize page data, or any combination thereof. The mid-end configuration module 102 is configured to determine page data to be pushed, page data to be updated, page data to be summarized, or any combination thereof in the page program.

3. An application module 103 is configured to integrate the generated page program and the configured application mid-end, to obtain an application program.

The embodiments of the present disclosure do not limit specific integration methods.

In some embodiments, the generated page program and the configured application min-end can be packaged to obtain a complete application. For example, Jenkins servers can be used for packaging.

In some embodiments, application module 103 can be configured to: parse the intermediate component of the page program into the actual executable code under the cross-platform framework to obtain an executable page program; and integrate the executable page program and the application mid-end to obtain the application program.

It should be noted that the obtained application can be directly executable or require secondary development.

In some embodiments, after the development of the above application development platform, there may be some areas that need further adjustment, so that secondary development can be carried out.

In addition, in an optional embodiment, for the overall application development platform, some of its functions can be modularized, so that the functional modules can be deployed, and corresponding services can be provided.

For example, the program development module can be deployed to provide functional services for page editing. The material management module can be deployed to provide functional services for material management.

Therefore, in some embodiments, the above application development platform may further include: a deployment module 105, configured to deploy at least one module of the application development platform to a demand side according to requirements of the demand side.

Corresponding to the above platform embodiments, the embodiments of the present disclosure further provide a corresponding method embodiment.

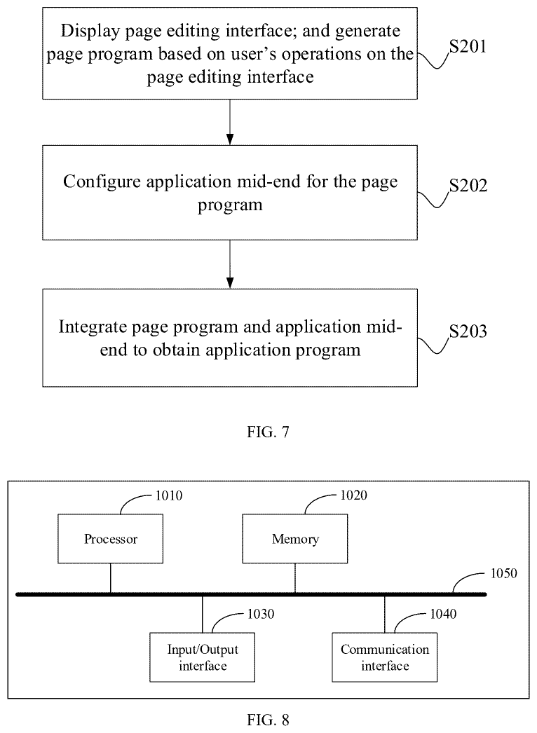

FIG. 7 is a flowchart of an application development method according to the embodiments of the present disclosure. As shown in FIG. 7,

In S201, a page editing interface is displayed; and a page program is generated based on user's operations on the page editing interface.

In some embodiments, operations on the page editing interface may include generating a page layout using materials and components, and configuring page information for the generated page layout.

In S202, an application mid-end is configured for the page program.

In S203, the page program and the application mid-end is integrated to obtain an application program.

In some embodiments, generating the page program user's operations on the page editing interface includes: by a pre-developed conversion module, converting a user's operation on the page editing interface into an intermediate component used to represent a page layout and/or page information in the page layout, and generating a page program composed of the intermediate component.

In some embodiments, the conversion module may be developed based on a cross-platform framework. The intermediate component can be configured to be parsed into actual executable code under the cross-platform framework.

In some embodiments, integrating the page program and the application mid-end to obtain the application program may include: parsing the intermediate component of the page program into the actual executable code under the cross-platform framework to obtain an executable page program; and integrating the executable page program and the application mid-end to obtain the application program.

In some embodiments, the above method may further include: displaying a material editing interface; and according to a user's operation on the material editing interface, generating a new edited material based on an existing material.

In some embodiments, according to the user's operation on the material editing interface, generating the new edited material based on the existing material includes: according to the user's operation on the material editing interface, by a basic material component pre-determined based on the cross-platform framework, converting a basic material component combination corresponding to the existing material into a basic material component combination corresponding to the new edited material; where the basic material component is configured to be parsed into a basic material under the cross-platform framework.

In some embodiments, page information may include page attribute information, page event information, page data information, page interaction information, page-to-page relationship information, or any combination thereof.

In some embodiments, the application mid-end is configured to push page data, update page data, summarize page data, or any combination thereof; and configuring the application mid-end for the page program includes: determining page data to be pushed, page data to be updated, page data to be summarized, or any combination thereof in the page program.

In some embodiments, the above method may further include: deploying at least one module of the application development platform to a demand side according to requirements of the demand side.

Specific explanations can be found in the above platform embodiments.

The embodiments of the present disclosure further provide a computer device including a memory, a processor, and a computer program that is stored in the memory and runnable on the processor, where the processor when executing the program, implements any one of the above method embodiments.

The embodiments of the present disclosure further provide an electronic device including: one or more processors, and one or more memories in communication with the one or more processor. The one or more memories store instructions that can be executed by the one or more processors, and the one or more processors when executing the instructions implements the method according to any one of the above method embodiments.

FIG. 8 is a schematic diagram of a hardware structure of a computer device configured to perform methods of the embodiments of the present disclosure according to the embodiments of the present disclosure. The device may include: a processor 1010, a memory 1020, an input/output interface 1030, a communication interface 1040, and a bus 1050. The processor 1010, memory 1020, input/output interface 1030, and communication interface 1040 are connected to each other through the bus 1050 for communication within the device.

Processor 1010 can be implemented using a general CPU (Central Processing Unit), microprocessor, Application Specific Integrated Circuit (ASIC), or one or more integrated circuits to execute related programs to implement the technical solution provided in the embodiments of the present disclosure.

Memory 1020 can be implemented in the form of ROM (Read Only Memory), RAM (Random Access Memory), static storage devices, dynamic storage devices, etc. Memory 1020 can store operating systems and other application programs. When implementing the technical solution provided in the embodiments of the present disclosure through software or hardware, the relevant program code is stored in memory 1020 and called and executed by processor 1010.

Input/output interface 1030 is used to connect input/output modules for information input and output. The input/output/module can be configured as a component in the device (not shown in the drawings), or can be externally connected to the device to provide corresponding functions. The input devices can include keyboards, mice, touch screens, microphones, various sensors, etc., while the output devices can include displays, speakers, vibrators, indicator lights, etc.

Communication interface 1040 is used to connect communication modules (not shown in the drawings) to achieve communication interaction between the device and other devices. The communication module can be achieved through wired methods (such as USB, Ethernet cables, etc.), as well as wireless methods (such as mobile networks, WIFI, Bluetooth, etc.).

Bus 1050 includes a path for transmitting information between various components of the device, such as processor 1010, memory 1020, input/output interface 1030, and communication interface 1040.

It should be noted that although the above device only illustrates processor 1010, memory 1020, input/output interface 1030, communication interface 1040, and bus 1050, in the specific implementation process, the device may further include other components necessary for normal operation. In addition, those skilled in the art can understand that the above-mentioned devices may only include the components necessary to implement the embodiments of the present disclosure, without necessarily including all the components shown in the drawings.

The embodiments of the present disclosure further provide a computer-readable storage medium on which a computer program is stored, and any one of the above method embodiments are implemented when the program is executed by a processor.

The embodiments of the present disclosure further provide a computer-readable storage medium storing a computer program, when the computer program is executed by a processor, any one of the above method embodiments is implemented.

Computer readable media include permanent and non-permanent, removable and non-removable media that can be implemented by any method or technology to store information. Information may be computer readable instructions, data structures, modules of a program, or other data. Examples of storage media for computers include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, compact disc read only memory (CDROM), digital versatile disc (DVD) or other optical storage, magnetic cartridge tape, magnetic tape magnetic disk storage, other magnetic storage device or any other non-transport medium that can be used to store information that can be accessed by a computing device. As defined herein, computer readable media does not include transitory computer readable media, such as modulated data signals and carriers.

Through the description of the above embodiments, those skilled in the art can clearly understand that the methods of the above embodiments can be implemented by means of software plus a necessary general-purpose hardware platform. Based on this understanding, the technical solutions of the embodiments of the present disclosure can essentially or in other words, contribute in the form of software products, which can be stored in storage media such as ROM/RAM, disks, CDs, etc., including several instructions to enable a computer device (which can be a personal computer, server, or network device, etc.) to execute the methods described in various embodiments or certain parts of the embodiments of the present disclosure.

The systems, apparatuses, modules, or units elucidated in the above embodiments can be implemented specifically by a computer chip or entity, or by a product with certain functions. A typical implementation device is a computer, which can take the form of a personal computer, laptop, cellular phone, camera phone, smart phone, personal digital assistant, media player, navigation device, email sending and receiving device, game console, tablet computer, wearable device, or any combination of these devices.

The various embodiments in the present disclosure are described in a progressive manner, and the same or similar parts between the various embodiments may be referred to each other, and each embodiment focuses on the differences from other embodiments. In particular, for the apparatus embodiments, since it is basically similar to the method embodiment, the description is relatively simple, and for related parts, please refer to the partial description of the method embodiment. The apparatus embodiments described above are only illustrative, and the modules described as separate components may or may not be physically separate. When implementing the embodiments of the present disclosure, the functions of each module can be implemented in the same or multiple software and/or hardware. Part or all of the modules may be selected according to actual requirements to implement the objectives of the solutions in the examples. A person skilled in the art can understand and implement without creative work.

The above are only specific implementations of the embodiments of the present disclosure. It should be pointed out that for ordinary technical personnel in the art, several improvements and embellishments can be made without departing from the principles of the embodiments of the present disclosure. These improvements and embellishments should also be considered as protection of the embodiments of the present disclosure.

In the present disclosure, the terms “first” and “second” are only for descriptive purposes, and cannot be understood as indicating or implying relative importance. The term “multiple” means two or more, unless otherwise clearly defined.

After considering and practicing the disclosure of the specification, other embodiments of the present disclosure will be readily apparent to those skilled in the art. The present disclosure is intended to cover any modification, use or adaptation of the present disclosure. These modifications, uses or adaptations follow the general principles of the present disclosure and include common knowledge and conventional technical means in the technical field that are not disclosed in the present disclosure. The specification and embodiments herein are intended to be illustrative only and the real scope and spirit of the present disclosure are indicated by the following claims of the present disclosure.

It is to be understood that the present disclosure is not limited to the precise structures described above and shown in the accompanying drawings and may be modified or changed without departing from the scope of the present disclosure. The scope of protection of the present disclosure is limited only by the appended claims.

1-9. (canceled)

10. An application development method, comprising:
displaying a page editing interface; and generating a page program according to an operation of a user on the page editing interface, wherein the operation comprises generating a page layout using materials and components, and configuring page information for the page layout;
configuring an application mid-end for the page program; and
integrating the page program and the application mid-end to obtain an application program.

11. The method according to claim 10, wherein generating the page program according to the operation of the user on the page editing interface comprises:
converting the operation of the user on the page editing interface into an intermediate component used to represent a page layout and/or page information in the page layout, and generating a page program composed of the intermediate component.

12. The method according to claim 11, wherein the intermediate component is configured to be parsed into actual executable code under the cross-platform framework.

13. The method according to claim 12, wherein integrating the page program and the application mid-end to obtain the application program comprises:
parsing the intermediate component of the page program into the actual executable code under the cross-platform framework to obtain an executable page program; and
integrating the executable page program and the application mid-end to obtain the application program.

14. The method according to claim 10, further comprising:
displaying a material editing interface; and
according to an operation of the user on the material editing interface, generating a new edited material based on an existing material.

15. The method according to claim 14, wherein according to the operation of the user on the material editing interface, generating the new edited material based on the existing material comprises:
according to the operation of the user on the material editing interface, by a basic material component pre-determined based on the cross-platform framework, converting a basic material component combination corresponding to the existing material into a basic material component combination corresponding to the new edited material; wherein the basic material component is configured to be parsed into a basic material under the cross-platform framework.

16. The method according to claim 10, wherein the page information comprises: page attribute information, page event information, page data information, page interaction information, page-to-page relationship information, or any combination thereof.

17. The method according to claim 10, wherein the application mid-end is configured to push page data, update page data, summarize page data, or any combination thereof; and configuring the application mid-end for the page program comprises:
determining page data to be pushed, page data to be updated, page data to be summarized, or any combination thereof in the page program.

18. The method according to claim 10, further comprising:
deploying at least one module of the application development platform to a demand side according to requirements of the demand side.

19. A electronic device, comprising:
one or more processors; and
one or more memories communicatively connected to the one or more processors;
wherein the one or more memories store instructions that can be executed by the one or more processors, and the one or more processors when executing the instructions implements an application development method comprising:
displaying a page editing interface; and generating a page program according to an operation of a user on the page editing interface, wherein the operation comprises generating a page layout using materials and components, and configuring page information for the page layout;
configuring an application mid-end for the page program; and
integrating the page program and the application mid-end to obtain an application program.

20. A non-transitory computer-readable storage medium storing a computer program, wherein the computer program when executed by a processor, implements an application development method comprising:
displaying a page editing interface; and generating a page program according to an operation of a user on the page editing interface, wherein the operation comprises generating a page layout using materials and components, and configuring page information for the page layout;
configuring an application mid-end for the page program; and
integrating the page program and the application mid-end to obtain an application program.

21. The electronic device according to claim 19, wherein generating the page program according to the operation of the user on the page editing interface comprises:
converting the operation of the user on the page editing interface into an intermediate component used to represent a page layout and/or page information in the page layout, and generating a page program composed of the intermediate component.

22. The storage medium according to claim 20, wherein generating the page program according to the operation of the user on the page editing interface comprises:
converting the operation of the user on the page editing interface into an intermediate component used to represent a page layout and/or page information in the page layout, and generating a page program composed of the intermediate component.

23. The storage medium according to claim 22, wherein the intermediate component is configured to be parsed into actual executable code under the cross-platform framework.

24. The storage medium according to claim 23, wherein integrating the page program and the application mid-end to obtain the application program comprises:
parsing the intermediate component of the page program into the actual executable code under the cross-platform framework to obtain an executable page program; and
integrating the executable page program and the application mid-end to obtain the application program.

25. The storage medium according to claim 20, wherein the application development further comprises:
displaying a material editing interface; and
according to an operation of the user on the material editing interface, generating a new edited material based on an existing material.

26. The storage medium according to claim 25, wherein according to the operation of the user on the material editing interface, generating the new edited material based on the existing material comprises:
according to the operation of the user on the material editing interface, by a basic material component pre-determined based on the cross-platform framework, converting a basic material component combination corresponding to the existing material into a basic material component combination corresponding to the new edited material; wherein the basic material component is configured to be parsed into a basic material under the cross-platform framework.

27. The storage medium according to claim 20, wherein the page information comprises: page attribute information, page event information, page data information, page interaction information, page-to-page relationship information, or any combination thereof.

28. The storage medium according to claim 20, wherein the application mid-end is configured to push page data, update page data, summarize page data, or any combination thereof; and configuring the application mid-end for the page program comprises:
determining page data to be pushed, page data to be updated, page data to be summarized, or any combination thereof in the page program.

29. The storage medium according to claim 20, wherein the application development method further comprises:
deploying at least one module of the application development platform to a demand side according to requirements of the demand side.
